(19) United States
(12) Patent Application Publication
(10) Pub. No.: US 2023/0153079 A1
(43) Pub. Date: May 18, 2023

(54) VISUAL REPRESENTATIONS OF SOURCE CODE PORTIONS IN INTEGRATED DEVELOPMENT ENVIRONMENTS

(71) Applicant: Red Hat, Inc., Raleigh, NC (US)

(72) Inventors: Paolo Antinori, Novara (IT); Eric Wittmann, Newtown, CT (US)

(21) Appl. No.: 17/528,337

(22) Filed: Nov. 17, 2021

(51) Int. Cl. G06F 8/34

(52) U.S. Cl. CPC G06F 8/34

(57) ABSTRACT

An integrated development environment (IDE) receives an indication of a selected source code portion within source code. A visual representation corresponding to the selected source code portion is identified in view of a set of mappings, wherein the set of mappings includes a mapping defined between the visual representation and the selected source code portion. The visual representation corresponding to the selected source code portion is displayed as a rendering preview of the selected source code portion.

### TECHNICAL FIELD

The disclosure is generally related to integrated development environments (IDEs), and more particularly, to visual representations of source code portions in IDEs.

### BACKGROUND

An integrated development environment (IDE) provides programmers with a set of tools that assist in the development and/or management of software programs. For example, an IDE can provide editing and/or debugging software for programmers. An IDE supports software development by providing a windowed system for source file editing, project management, file interdependency management, and debugging. As another example, an IDE can assist in the management of source files and binary files, program compiling, source file editing and similar tasks associated with software development. Some IDEs may be structured as plug-in based software models where the components of the IDE are structured as plug-ins for the IDE.

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 depicts a block diagram of an example computer system architecture, in accordance with one or more aspects of the disclosure.

FIG. 2A depicts a flow diagram of an example method for providing a visual representation of a source code portion, in accordance with some embodiments.

FIG. 2B depicts a flow diagram of an example method for providing a visual representation of a source code portion, in accordance with some embodiments.

FIG. 3 depicts a flow diagram of an example method for obtaining a set of mappings between at least one visual representation and at least one respective source code element, in accordance with some embodiments.

FIG. 4A depicts example source code to illustrate mapping source code portions to respective visual representations of the source code portions, in accordance with some embodiments.

FIG. 4B depicts example source code corresponding to a configuration file for mapping source code portions to respective visual representations of the source code portions, in accordance with some embodiments.

FIG. 5 depicts a diagram of an example visual representation, in accordance with some embodiments.

FIG. 6 depicts a block diagram of an illustrative computing device operating in accordance with the examples of the disclosure.

### DETAILED DESCRIPTION

Described herein are systems and methods to enable visual representations of components in integrated development environments (IDEs). One goal of software development (e.g., web application development) is the rendering of visual components. These visual components can be placed in the correct context for producing an accurate rendering. For example, for a visual component including a button utilizing the Cascading Style Sheets (CSS) style sheet language, the button should be placed inside the correct division block to inherit the correct visual instructions according to the cascading behavior of CSS. This process can make it difficult to read and navigate a large codebase.

Software developers can utilize a live preview server that processes the source code of an entire application and returns a complete page. However, this approach can be computationally inefficient for large codebases since there is a time and resource cost for rendering the entire codebase for the application. Furthermore, this approach does not offer a sufficiently low level of granularity that can assist developers with understanding how a specific section of the source code affects the rendering. More specifically, software developers may only see the complete output and thus have to utilize other tools, outside of their code editor, to explore the output. For example, software developers may perform a reverse lookup in the source files to understand which portion of the output maps to the source code.

Aspects of the disclosure address the above and other deficiencies by providing technology that enables visual representations of source code portions (e.g., modules) in integrated development environments (IDEs). Visual representations of source code portions described herein can simplify the exploration of source code (e.g., codebase) of a visually-oriented application (e.g., web application) by visually representing objects that are described by various areas of the source code, thereby reducing computational resource costs associated with source code exploration. For example, a visual representation can be a visual preview of the rendering of a selected source code portion. In some embodiments, the visual representation can be a static image. Additionally or alternatively, an overlay window can be provided that displays the visual representation. The overlay window can follow the developer's cursor (e.g., controlled by a mouse or other hand-held pointing device), or could be activated in a modal window when needed, which enables compatibility with cursor-based text navigation. The visual representation can be stored within IDE project files, or can be versioned in a specific subfolder of the source code, which can make the visual representation portable and accessible to software developers that have a copy of the source code for the software project. In some embodiments, the functionality can be implemented as a web browser extension for utilization with respect to online source code repositories. This can provide users of such online source code repositories with the ability to enable visual representations of source code of a project, even when they are simply “reading” the source code of the project in a browser tab.

The IDE can obtain and maintain mappings between the source code portions and visual representations representing the rendering of visual component(s) of respective ones of the source code portions. Embodiments described herein can provide a number of mechanisms for obtaining mappings between source code portions and respective visual representations. For example, a configuration file can be generated that includes mapping configurations for explicitly mapping visual representations to respective source code portions (e.g., HTML source code portions). Additionally or alternatively, mapping by naming convention can be used to bind source code portion attributes (e.g., HTML source code portion attributes) to visual representation file names if the visual representation files are already present on a local folder. Additionally or alternatively, if an application is an existing application that renders as expected, an automated process can be used to generate the mappings. For example, if the application is a web application, a web browser can be used to automatically scan the entire source code of the web application for HTML source code portions, and automatically trigger a screenshot of a sub-portion of the Document Object Model (DOM) to a previously configured URL, or pass a command to spawn a local development server capable of serving the web application. Additionally or alternatively, a User Experience (UX) tool (e.g., driver) can be used to extend functionality of user interface (UI) design platforms. For example, the UX tool can export a visual representation generated within a UI design platform, and analyze the corresponding metadata of the visual representation to produce a naming convention input for mapping to a particular source code portion. This process can be automated with a recurring export/synching that continuously provides domain updates.

Therefore, the systems and methods described herein include technology that enhances utilization of computing resources, such as processor usage and memory usage, for a computer system. In particular, aspects of the disclosure provide technology that enhances the efficiency and/or performance of a computing system by reducing processor and memory usage and improving network bandwidth (e.g., by reducing resources used to navigate source code). Various aspects of the above referenced methods and systems are described in details herein below by way of examples, rather than by way of limitation.

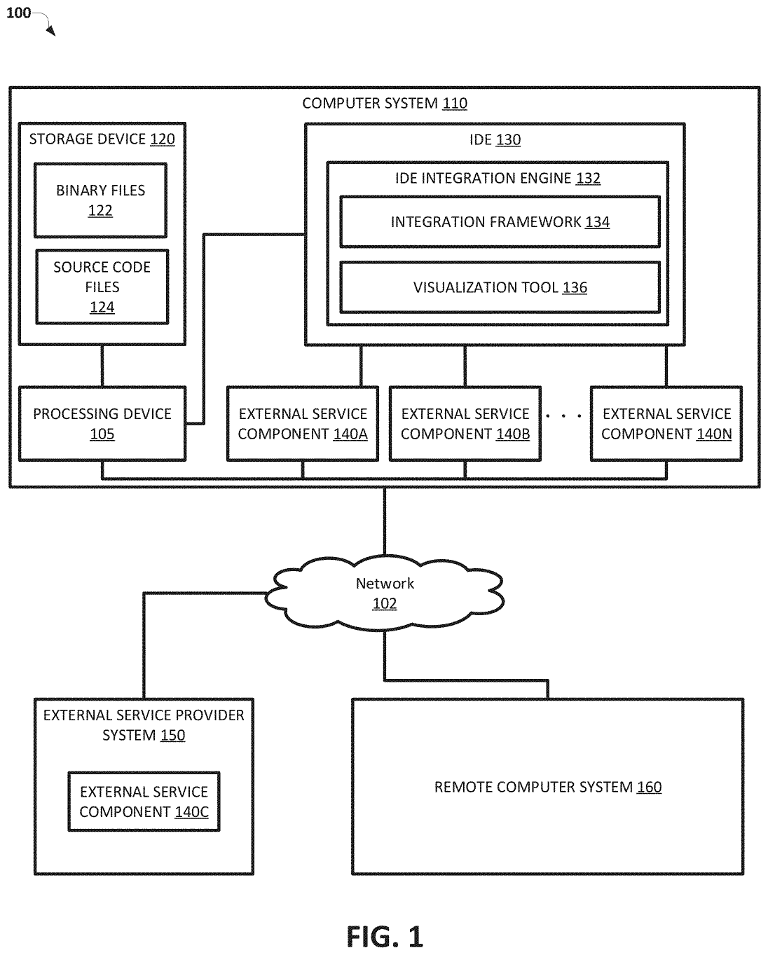

FIG. 1 is a diagram of one embodiment of an example computer system architecture (“architecture”) 100, in accordance with some embodiments. The architecture 100 can include a computer system 110 that includes at least one processing device 105, at least one storage device 120, and implements an integrated development environment (IDE) 130 and a set of stand-alone external service components 140A-140N. The computer system 110 can be any type of computing device including a desktop computer, a workstation, a dedicated server, a handheld device or a similar computing device. Although the computer system 110 is shown including a single processing device 105, the computer system 110 can include any type and number of processing devices. For example, the processing device 105 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Although the computer system 110 is shown including a single storage device 120, the computer system 110 can include any type and number of storage devices. For example, the storage device 120 can be a fixed disk drive, removable storage medium drive that is an external drive or internal drive, random access memory (RAM), static memory or similar storage device, etc. The storage device 120 can be used to store a set of binary files 122 and source code files 124, as well as installed programs and tools including the IDE 130 and external service components 140A-140N. The binary files 122 and source code files 124 are data files that are part of a programming project managed by the IDE 130. The binary files 122 may refer to compiled code generated from the source code files 124. The source code files 124 may refer to one or more sets of program instructions. The IDE 130 is an application for assisting a user in developing and/or managing a software programming project.

The set of external service components 140A-140N can include one or more of an email program, a real-time communication program such as an instant messaging (IM) program, a code hosting service for version control, a source code management system, a CI/CD system, a container platform system, and/or any other tool or service used in the software development lifecycle. In some implementations, at least one external service component of the set of external service components 140A-140N can be hosted on at least one external service provider system external to the computer system 110 hosting the IDE 130, such as an external service provider system 150 hosting the external service component 140C.

In one implementation, the IDE 130 implements an integration engine to enable the integration of the set of external service components 140A-140N in the IDE 130. In one implementation, the IDE 130 and the IDE integration engine 132 are a part of a distributed system. In the distributed system embodiment, the computer system 110 communicates over a network 102 with the external service provider system 150 and at least one remote computer system 160. The remote computer system 160 can have similar components to the computer system 110 (e.g., a storage device similar to the storage device 120 and an IDE similar to the IDE 130). The network 102 may be a private network (e.g., a local area network (LAN), a wide area network (WAN), intranet, or other similar private networks) or a public network (e.g., the Internet). The distributed system can include any number of additional computer systems that incorporate similar features, functions and structures. The remote computer system 160 can be any type of computing device including a desktop computer, a workstation, a dedicated server, a handheld computer system or similar computing device. The network 102 can include any number of intermediate computing devices and network elements. The network 102 can include any number or combination of wired and wireless communication mediums between the nodes in the network. Any combination of resources can be provided over the network 102 by the remote computer system 160 the computer system 110. Similarly, the remote computer system 160 can interact with and utilize resources from the computer system 110 over the network 102. In this manner, the distributed computing environment enables the use of resources across the network 102 to access a larger range of resources that are distributed across each of the computer systems.

The IDE 130 can further include a set of integrated external service component tools (“tools”) each providing features to the IDE 130. For example, the set of tools can include a plug-in, an add-on, or any other functionality enabling customization of the IDE 130. The set of tools can interface with external service components 140A-140N and can assist the user in debugging, editing, compiling, deploying, testing, communicating, or similarly managing the project. The set of tools can be specific to the external service components 140A-140N for allowing a user to interface with the functionality of those external service components 140A-140N within the IDE 130. The set of tools can enable integration between the source code files 124 developed in the IDE 130 and the output of the external components 140A-140N.

For example, the set of tools may be associated with a defined set of tool-specific external service component functions (“functions”) and an integration framework 134. The set of functions can provide functionality for calling the set of external service components 140A-140N and passing parameters, such as a selected binary file, to the set of external service components 140A-140N. For example, the set of functions can include a procedure or routine that causes a particular task to be performed. The integration framework 134 can support interfacing with external utilities or programs, such as the set of external service components 140A-140N. The set of functions can utilize command line interfaces (CLIs) and/or application programming interfaces (APIs) of the set of external service components 140A-140N and make such interfaces accessible to the set of tools via the integration framework 134. Accordingly, the integration framework 134 defines a set of functions that provides access to data structures and resources of the IDE 130 to enable the interfacing of the IDE 130 with the set of external components 140A-140N and the utilization of the output of these components 140A-140N within the IDE 130.

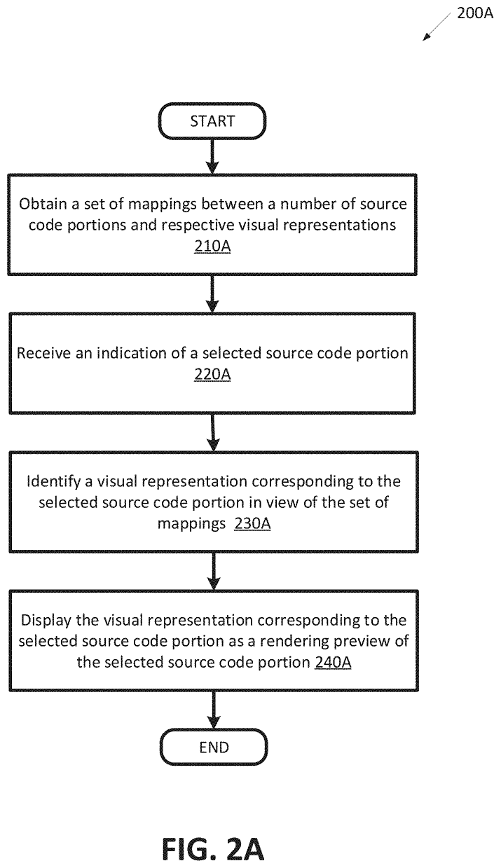

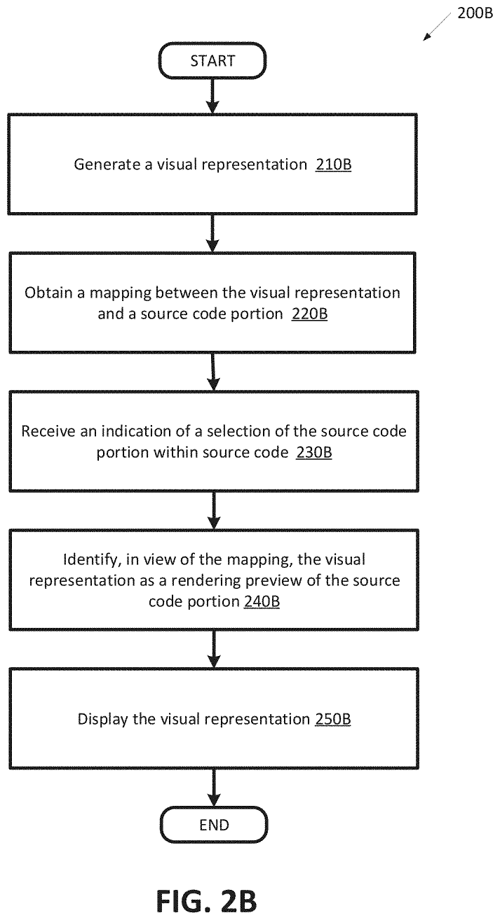

Illustratively, the set of tools can receive an indication of a selection of a source code portion of the source code files 124 (e.g., a portion of source code). The set of tools may then utilize the integration framework 134 to call an external service component 140A-140N. The integration framework 134 can return the output of the external service component 140A-140N. The set of tools can then process this output data for purposes of interacting with source code files 124 being developed in the IDE 130 in an integrated and convenient way. In some embodiments, the set of tools can include a visualization tool 136 that displays a visual representation of the selected source code portion. As such, the integration framework 134 can interface with the external service components 140A-140N in the IDE 130 to provide an integrated source code visualization experience. Further details regarding generating and displaying mappings between visual representations and source code portions will be described in further detail below with reference to FIGS. 2A-5.

The structures, functions, and principles described in regard to these specific examples are applicable to any external utility, program, or service that can be integrated and provided through a visual interface within the IDE 130, through a similar software structure, set of general function and tools. In further embodiments, the integration framework 134, the set of tools can be integrated into a monolithic plug-in or directly integrated into the IDE 130. Other permutations of these configurations are also within the scope of the invention.

An external service component of the set of external service components 140A-140N can be an email program. The email program can receive source code, and can utilize one or more functions to process and interact with the source code (e.g., generate an email message including the source code, addressed to a determined owner of the source code).

Additionally or alternatively, an external service component of the set of external service components 140A-140N can include a real-time communication program (e.g., instant messaging program). The real-time communication program can receive source code, and can utilize one or more functions to initiate a real-time discussion (e.g., instant message) relating to the source code.

Additionally or alternatively, an external service component of the set of external service components 140A-140N can include an external service component to perform CI/CD builds. Here, the external service component can receive the selected source code, and trigger an automated build in a CI/CD environment based on the selected source code portion. Using the IDE integration engine 132, a list of jobs defined in the CI/CD environment can be obtained and at least one of those jobs can be triggered with the selected source code portion from the IDE 130.

Additionally or alternatively, an external service component of the set of external service components 140A-140N can include a deployment program. The deployment program can receive the selected source code, and deploy the selected source code to a container of a container platform system. The container may be hosted on the computer system 110 or on an external computer system, such as the systems 150 or 160.

Additionally or alternatively, an external service component of the set of external service components 140A-140N can include a code quality program. The code quality program can receive the selected source code, and submit the selected source code to a code quality system to analyze the quality of the code.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or memory page media.

FIG. 2A depicts a flow diagram of an example method 200A for providing a visual representation of a source code portion, in accordance with some embodiments. For example, the method 200A may be performed by IDE integration engine 132 as shown in FIG. 1. Method 200A may be performed by one or more processing devices that may comprise hardware (e.g., circuitry, dedicated logic, programmable logic, microcode, etc.), executable code (such as is run on a general purpose computer system or a dedicated machine), or a combination of both. For example, the one or more processing devices can perform individual functions, routines, subroutines, or operations to implement the method 200A.

At block 210A, processing logic obtains a set of mappings between a number of source code portions and respective visual representations. For example, the source code portions can be portions of source code that is being edited via an IDE. In some embodiments, the source code can correspond to a web application, and the source code portions can include at least one HTML source code portion. In some embodiments, the visual representations include static images.

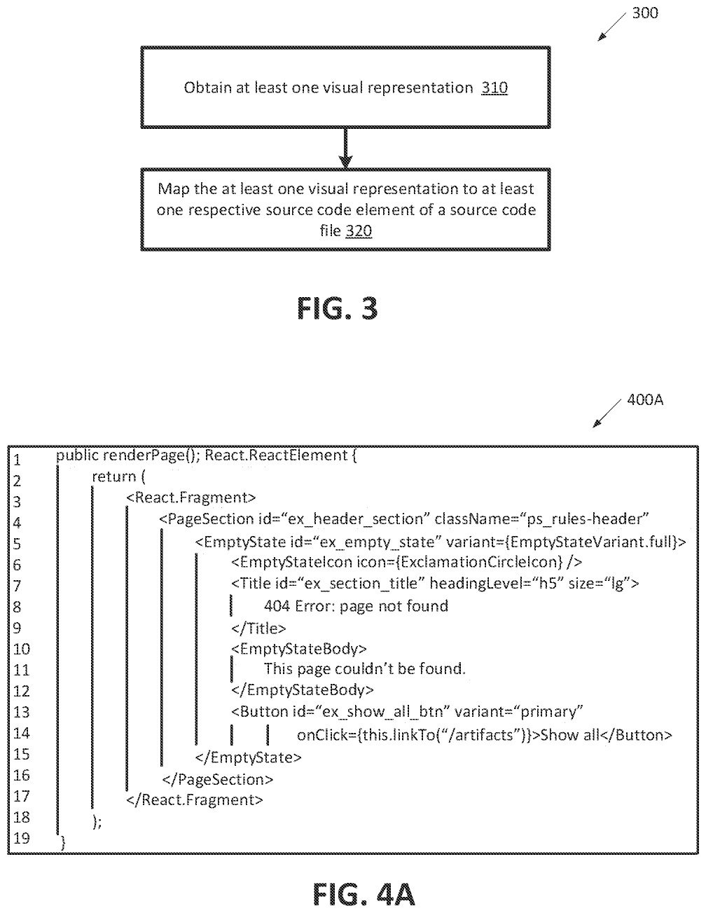

For example, obtaining the set of mappings can include receiving the set of mappings from a repository (e.g., a pre-generated set of mappings). As another example, as will be described in further detail below with reference to FIG. 3, obtaining the set of mappings can include generating the set of mappings.

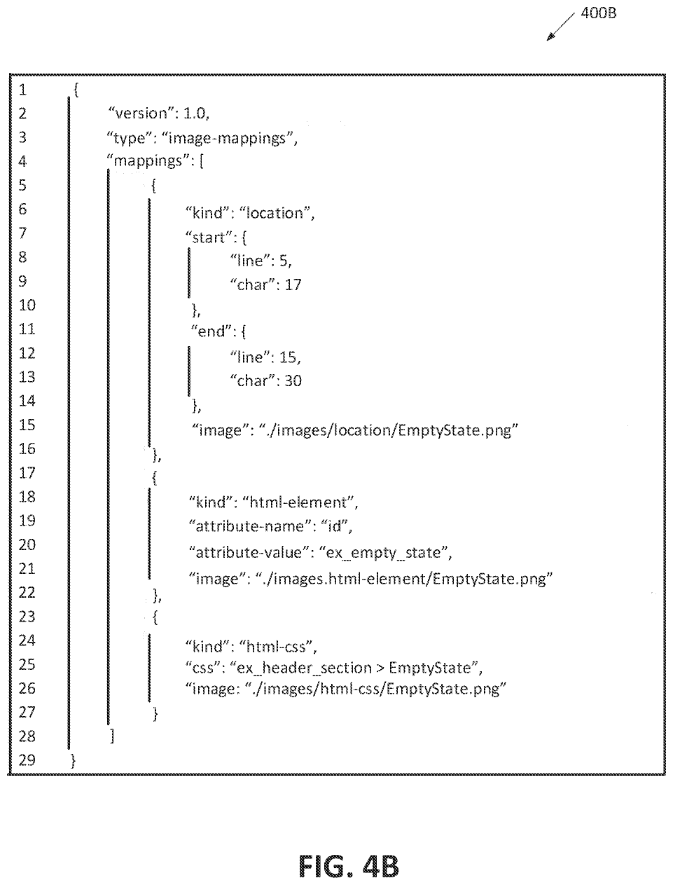

In some embodiments, the set of mappings is generated using a mapping by naming convention. Here, the visual representations are named in a manner in which the IDE can find an appropriate visual representation for a selected source code portion in the source code. A source code portion can support one or more attributes that can be used for mapping by naming convention. For example, if the source code portion is an HTML source code portion, an attribute of the HTML source code portion can be used. The attribute can include an attribute name and an attribute value. More specifically, a user can specify a unique attribute value for a given HTML source code portion in the source code, and ensure that the visual representation created for the given HTML source code portion is named based on the unique attribute value. Further details regarding mapping by naming convention will be described below with reference to FIG. 3, and illustrative examples of attributes of HTML source code portions will be described in further detail below with reference to FIG. 4A.

In some embodiments, the set of mappings is obtained based on mapping by external configuration file. The mapping by configuration file approach can be more flexible than mapping by naming convention approach. Here, a configuration file can be created to explicitly map source code portions to respective visual representations. The visual representations identified in the configuration file can be stored either locally or remotely.

The configuration file can include a list of mappings. For example, a particular mapping can include (A) a pointer to a location in the corresponding source code file, and (B) a path to the visual representation for particular mapping. With respect to (A), any number of configurations can be used to identify the location in the source code file with respect to the pointer. Such configurations can be based on the path to source code file. Examples of such approaches include (1) path to source code file+starting line number+starting character location+ending line number+ending character location; (2) path to source code file+source code portion attribute name and value; and (3) path to source code file+CSS path to source code portion. With respect to (B), the path can be an absolute file path containing the full path to the visual representation, or a relative file path containing a path to the visual representation relative to a current directory. Further details regarding mapping by configuration file will be described below with reference to FIG. 3, and examples of configuration file formats will be described in further detail below with reference to FIG. 4B.

At block 220A, processing logic receives an indication of a selected source code portion. For example, the indication can be received in response to detecting that a cursor is hovering over a particular source code portion within source code being edited via the IDE. As another example, the indication can be received in response to an active selection of a particular source code portion (e.g., a user using a mouse or other input device that can select text). In some embodiments, the selected source code portion is an HTML source code portion.

At block 230A, processing logic identifies a visual representation corresponding to the selected source code portion in view of the set of mappings and, at block 240A, processing logic displays the visual representation corresponding to the selected source code portion as a rendering preview of the selected source code portion. For example, the visual representation can be a static image of the rendering of the selected source code portion after the compiling of the source code. Thus, the user can accurately visualize a representation of how the selected source code portion will appear, on-the-fly, without having to render any of the source code (e.g., web application). Examples of static image files include Portable Network Graphics (PNG) image files, Joint Photographic Experts Group (JPEG) image files, Graphical Interchange Format (GIF) image files, etc.

FIG. 2B depicts a flow diagram of an example method 200B for providing a visual representation of a source code portion, in accordance with some embodiments. For example, the method 200B may be performed by IDE integration engine 132 as shown in FIG. 1. Method 200B may be performed by one or more processing devices that may comprise hardware (e.g., circuitry, dedicated logic, programmable logic, microcode, etc.), executable code (such as is run on a general purpose computer system or a dedicated machine), or a combination of both. For example, the one or more processing devices can perform individual functions, routines, subroutines, or operations to implement the method 200B.

At block 210B, processing logic generates a visual representation. For example, the visual representation can be a static image corresponding to a static image file. Examples of static image files include PNG image files, JPEG image files, GIF image files, etc.

At block 220B, processing logic obtains a mapping between the visual representation and a source code portion. For example, the source code portion can be a portion of source code that is being edited via an IDE. In some embodiments, the source code can correspond to a web application, and the source code portion can include at least one HTML source code portion.

For example, obtaining the mapping can include receiving the mapping from a repository (e.g., from a pre-generated set of mappings). As another example, as will be described in further detail below with reference to FIG. 3, obtaining the mapping can include generating the mapping. For example, the mapping can be generated as part of a set of mappings.

In some embodiments, the mapping is generated using a mapping by naming convention. Further details regarding mapping by naming convention are described above with reference to FIG. 2A, and will be described in further detail below with reference to FIG. 3 and FIG. 4A. In some embodiments, the mapping is obtained based on mapping by external configuration file. Further details regarding mapping by configuration file are described above with reference to FIG. 2A, and will be described in further detail below with reference to FIG. 3 and FIG. 4B.

At block 230B, processing logic receives an indication of a selection of the source code portion within the source code. For example, the indication can be received in response to detecting that a cursor is hovering over a particular source code portion within source code being edited via the IDE. As another example, the indication can be received in response to an active selection of a particular source code portion (e.g., a user using a mouse or other input device that can select text). In some embodiments, the selected source code portion is an HTML source code portion.

At block 240B, processing logic identifies, in view of the mapping, a visual representation as a rendering preview of the source code portion and, at block 250B, processing logic displays the visual representation. For example, the visual representation can be a static image of the rendering of the selected source code portion after the compiling of the source code. Thus, the user can accurately visualize a representation of how the selected source code portion will appear, on-the-fly, without having to render any of the source code (e.g., web application). Examples of static image files include PNG image files, JPEG image files, GIF image files, etc.

FIG. 3 depicts a flow diagram of an example method 300 for obtaining a set of mappings between at least one visual representation and at least one respective source code element. For example, the method 300 may be performed by IDE integration engine 132 as shown in FIG. 1. Method 300 may be performed by one or more processing devices that may comprise hardware (e.g., circuitry, dedicated logic, programmable logic, microcode, etc.), executable code (such as is run on a general purpose computer system or a dedicated machine), or a combination of both. For example, the one or more processing devices can perform individual functions, routines, subroutines, or operations to implement the method 300.

At block 310, processing logic obtains at least one visual representation. For example, the at least one visual representation can include at least one static image file. Examples of static image files include PNG image files, JPEG image files, GIF image files, etc. In some embodiments, obtaining the at least one visual representation involves generating the at least one visual representation. Further details regarding generating the at least one visual representation will be described below.

At block 320, processing logic maps the at least one visual representation to at least one respective source code portion of a source code file. For example, the source code file can correspond to a web application, and the at least one source element can be an HTML source code portion. The mapping can be based on a naming convention, a configuration file, etc.

The at least one visual representation can be generated and/or mapped to the at least one respective source code portion during one or more phases of the development lifecycle of the corresponding source code (e.g., web application). For example, the at least one visual representation can be generated during at least one of the design phase of the development lifecycle, the implementation phase of the development lifecycle, or the end-to-end testing phase of the development lifecycle.

For example, during the design phase, a user (e.g., user experience (UX) designer) can employ one or more UX tools to generate visual representations of what a user interface (UI) should look like once implemented. Such UX tools can be modified and enhanced to produce sample source code for generating visual representations.

During the implementation phase, a user (e.g., software developer) can execute a development version of the UI software to test changes in real-time. The development version of the UI software could be modified and enhanced to produce screenshots of each page of the UI and output the screenshots as visual representations, along with creating a configuration file containing mappings of the visual representations to the locations of the corresponding source code portions in the source code. For example, the UI software can be modified and enhanced by employing a web browser plugin.

During the end-to-end testing phase, end-to-end UI tests that are created during the writing of the UI software can be executed whenever the application is being built using the CI/CD pipeline. Diagnostic tools that take screenshots when such end-to-end UI tests fail can be modified and enhanced to always take screenshots (for each page/action in the UI), along with creating the configuration file for mapping the visual representations to the locations of the corresponding source code portions in the source code.

FIG. 4A depicts example source code 400A to illustrate mapping source code components to respective visual representations of the source code components, in accordance with some embodiments. The source code 400A can be associated with a particular IDE. In this illustrative example, the source code 400A corresponds to at least a portion of a web application including a number of HTML source code portions each having a corresponding attribute defined by an attribute name and attribute value.

For example, the HTML source element elements include “PageSection” having a corresponding attribute name “id” and attribute value “ex_header_section” in line 4, “EmptyState” having a corresponding attribute name “id” and attribute value “ex_empty_state” in line 5, “Title” having a corresponding attribute name “id” and attribute value “ex_section_title” in line 7, and “Button” having a corresponding attribute name “id” and attribute value “ex_show_all_btn” in line 13. Visual representation files could then be created for each HTML source code portion based on their respective attributes. Illustratively, PNG static image files could be created with the names “ex_header_section.png”, “ex_empty_state.png”, “ex_section_title.png” and “ex_show_all_btn.png”. Then, the attribute value of each attribute can be mapped to the name of a corresponding visual representation file. For example, the attribute value “ex_header_section” can be mapped to the visual representation file “ex_header_section.png”, the attribute value “ex_empty_state” can be mapped to the visual representation file “ex_empty_state.png”, etc. Accordingly, this mapping by naming convention can enable the IDE to locate the appropriate visual representation file to display for a particular HTML source code portion of the source code 400A.

FIG. 4B depicts example source code 400B corresponding to a configuration file for mapping source code components to respective visual representations of the source code components, in accordance with some embodiments. The source code 400B can be associated with a particular IDE. In this illustrative example, the source code 400B corresponds to at least a portion of a web application including a number of HTML source code portions each having a corresponding attribute defined by an attribute name and attribute value.

For example, as indicated in line 3, the configuration file has a type “image-mappings”, where lines 4-28 illustrate three different examples of mapping configurations (“configurations”), where each configuration includes a set of information defining the mapping. For example, the set of information for a particular configuration can include (A) a pointer to a location in the corresponding source code file, and (B) a path to the visual representation for particular mapping. In this illustrative example, each of the first, second and third configurations points to the same “EmptyState” HTML source code portion within the source code 400A described above with reference to FIG. 4A.

A first configuration is defined by lines 5-16 as a “location” kind of mapping. The first configuration points to the location of the HTML source code portion “EmptyState” in the corresponding source code 400A based on starting and ending line numbers and starting and ending character locations. For example, having a starting line number of “5” and a starting character location of “17” within line 5, and an ending line number of “15” and an ending character location of “30” within line 15. The first configuration further defines a path to the visual representation “EmptyState.png” defined by a relative path “./images/location/EmptyState.png”.

A second configuration is defined by lines 17-22 as an “html-element” kind of mapping. Here, the second configuration points to the location of the HTML source code portion “EmptyState” in the corresponding source code 400A using the attribute name “id” and the attribute value “ex_empty_state”. Similar to the first configuration, the second configuration further defines a path to the visual representation “EmptyState.png” defined by a relative path “./images/location/EmptyState.png”.

A third configuration is defined by lines 23-27 as an “html-css” kind of mapping. Here, the third configuration points to the location of the HTML source code portion “EmptyState” in the corresponding source code 400A by using a CSS selector. In this illustrative example, the CSS selector is an id selector, indicated by the pound sign symbol #, which selects a specific HTML source code portion by its unique id attribute. For example, as shown, the HTML source code portion “EmptyState” is identifying using the id selector “#ex_header_section>EmptyState”. Similar to the first and second configuration, the third configuration further defines a path to the visual representation “EmptyState.png” defined by a relative path “./images/location/EmptyState.png”.

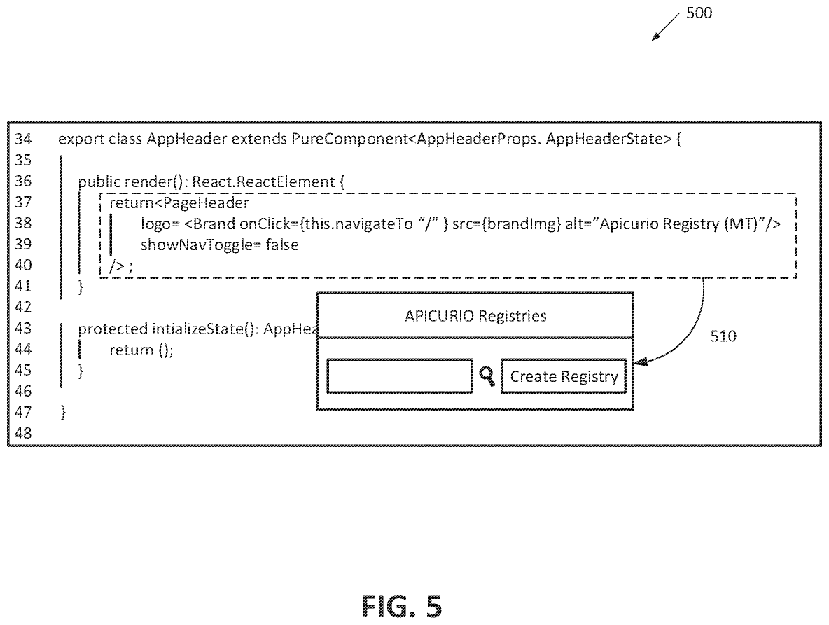

FIG. 5 depicts a diagram of an example portion of source code 500 illustrating a visual representation preview of a selected source code portion, in accordance with some embodiments. In this illustrative example, the source code corresponds to a web application and the selected source code portion, “PageHeader”, is an HTML source code portion. Upon receiving an indication of the selection of the selected source code portion “PageHeader” (as indicated by the highlighting in line 37), a visual representation 510 has automatically appeared as a preview of the corresponding page header. It is assumed that the visual representation 510 was mapped to the selected source code portion “PageHeader” using any suitable technique in accordance with implementations described herein. For example, the visual representation 510 could have been mapped by employing a naming convention, a configuration file, etc. In some embodiments, at least one of the visual representation 510 or the mapping was automatically generated using one or more tools. For example, the one or more tools can include one or more UX tools having functionality modified and enhanced to generate the visual representation 510 and/or the mapping between the visual representation 510 and the source code portion “PageHeader” of the source code 500.

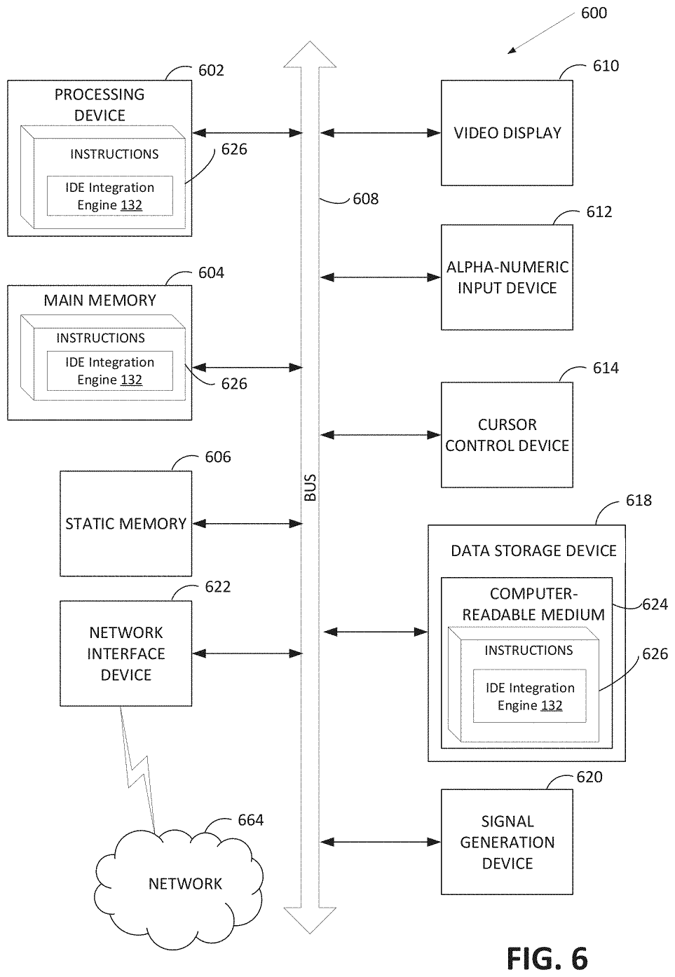

FIG. 6 depicts a block diagram of a computer system operating in accordance with one or more aspects of the disclosure. In various illustrative examples, computer system 600 may correspond to computer system 100 of FIG. 1. The computer system may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620. Data storage device 616 may include a non-transitory computer-readable storage medium 624 on which may store instructions 626 encoding any one or more of the methods or functions described herein, including instructions for implementing the IDE integration engine 132. Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Example 1 is a method comprising: receiving, by a processing device executing an integrated development environment (IDE), an indication of a selected source code portion within source code; identifying, by the processing device in view of a set of mappings, a visual representation corresponding to the selected source code portion, wherein the set of mappings comprises a mapping defined between the visual representation and the selected source code portion; and displaying, by the processing device, the visual representation corresponding to the selected source code portion as a rendering preview of the selected source code portion.

Example 2 is the method of Example 1, wherein the source code corresponds to a web application and the source code portion is an HTML source code portion.

Example 3 is the method of any of Examples 1-2, further comprising obtaining, by the processing device, the set of mappings, wherein obtaining the set of mappings comprises: generating the visual representation; and mapping the visual representation to the selected source code portion.

Example 4 is the method of any of Examples 1-3, wherein the set of mappings is comprised within a configuration file defining the mapping between the visual representation and the selected source code portion.

Example 5 is the method of Examples 1-4, wherein the mapping is defined by a pointer to a location of the selected source code portion within the source code, and a path to a visual representation file corresponding to the visual representation.

Example 6 is the method of Examples 1-5, wherein mapping the visual representation to the selected source code portion comprises naming a visual representation file corresponding to the visual representation in view of an attribute of the source code portion.

Example 7 is the method of any of Examples 1-6, wherein the visual representation is represented by a screenshot.

Example 8 a method comprising: obtaining a mapping between a visual representation and a source code portion; receiving an indication of a selection of the source code portion within source code; and identifying, in view of the mapping, the visual representation as a rendering preview of the source code portion.

Example 9 is the method of Example 8, wherein the source code corresponds to a web application and the source code portion is an HTML source code portion.

Example 10 is the method of any of Examples 8-9, further comprising displaying, by the processing device, the visual representation.

Example 11 is the method of any of Examples 8-10, wherein: the set of mappings is comprised within a configuration file defining the mapping between the visual representation and the selected source code portion; and the mapping is defined by a pointer to a location of the selected source code portion within the source code, and a path to a visual representation file corresponding to the visual representation.

Example 12 is the method of any of Examples 8-11, wherein obtaining the mapping between the visual representation and the source code portion comprises naming a visual representation file corresponding to the visual representation in view of an attribute of the source code portion.

Example 13 is the method of any of Examples 8-12, wherein the visual representation is represented by a screenshot.

Example 14 is a system comprising: a memory; and a processing device executing an integrated development environment (IDE), operatively coupled to the memory, to perform operations comprising: receiving an indication of a selected source code portion within source code; identifying, in view of a set of mappings, a visual representation corresponding to the selected source code portion, wherein the set of mappings comprises a mapping defined between the visual representation and the selected source code portion; and displaying the visual representation corresponding to the selected source code portion as a rendering preview of the selected source code portion.

Example 15 is the system of Example 14, wherein the source code corresponds to a web application and the source code portion is an HTML source code portion.

Example 16 is the system of any of Examples 14-15, wherein the operations further comprise obtaining the set of mappings, and wherein obtaining the set of mappings comprises: generating the visual representation; and mapping the visual representation to the selected source code portion.

Example 17 is the system of any of Examples 14-16, wherein the set of mappings is comprised within a configuration file defining the mapping between the visual representation and the selected source code portion.

Example 18 is the system of any of Examples 14-17, wherein the mapping is defined by a pointer to a location of the selected source code portion within the source code, and a path to a visual representation file corresponding to the visual representation.

Example 19 is the system of any of Examples 14-18, wherein mapping the visual representation to the selected source code portion comprises creating a visual representation file corresponding to the visual representation having a name defined in view of an attribute value of the source code portion.

Example 20 is the system of any of Examples 14-19, wherein the visual representation is represented by a screenshot.

Example 21 is a non-transitory machine-readable storage medium storing instructions that, when executed by a processing device executing an integrated development environment (IDE), cause the processing device to perform operations comprising: receiving an indication of a selected source code portion within source code, identifying, in view of a set of mappings, a visual representation corresponding to the selected source code portion, wherein the set of mappings comprises a mapping defined between the visual representation and the selected source code portion, displaying the visual representation corresponding to the selected source code portion as a rendering preview of the selected source code portion.

Example 22 is the non-transitory computer readable storage medium of Example 21, wherein the source code corresponds to a web application and the source code portion is an HTML source code portion.

Example 23 is the non-transitory computer readable storage medium of any of Examples 21-22, wherein the operations further comprise displaying the visual representation.

Example 24 is the non-transitory computer readable storage medium of any of Examples 21-23, wherein: the set of mappings is comprised within a configuration file defining the mapping between the visual representation and the selected source code portion; and the mapping is defined by a pointer to a location of the selected source code portion within the source code, and a path to a visual representation file corresponding to the visual representation.

Example 25 is the non-transitory computer readable storage medium of any of Examples 21-24, wherein obtaining the mapping between the visual representation and the source code portion comprises naming a visual representation file corresponding to the visual representation in view of an attribute of the source code portion.

Example 26 is the non-transitory computer readable storage medium of any of Examples 21-25, wherein the visual representation is represented by a screenshot.

Example 27 is an apparatus comprising: a processing device; means for receiving an indication of a selected source code portion within source code; means for identifying, in view of a set of mappings, a visual representation corresponding to the selected source code portion, wherein the set of mappings comprises a mapping defined between the visual representation and the selected source code portion; and means for displaying the visual representation corresponding to the selected source code portion as a rendering preview of the selected source code portion.

Example 28 is the apparatus of Example 27, wherein the source code corresponds to a web application and the source code portion is an HTML source code portion.

Example 29 is the apparatus of any of Examples 27-28, further comprising: means for obtaining the set of mappings, and wherein the means for obtaining the set of mappings comprises: means for generating the visual representation; and means for mapping the visual representation to the selected source code portion.

Example 30 is the apparatus of any of Examples 27-29, wherein the set of mappings is comprised within a configuration file defining the mapping between the visual representation and the selected source code portion.

Example 31 is the apparatus of any of Examples 27-30, wherein the mapping is defined by a pointer to a location of the selected source code portion within the source code, and a path to a visual representation file corresponding to the visual representation.

Example 32 is the apparatus of any of Examples 27-31, wherein the means for mapping the visual representation to the selected source code portion comprises means for creating a visual representation file corresponding to the visual representation having a name defined in view of an attribute value of the source code portion.

Example 33 is the apparatus of any of Examples 27-32, wherein the visual representation is represented by a screenshot.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner. In certain implementations, not all operations or sub-operations of the methods herein are required to be performed.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “receiving,” “identifying,” “displaying,” “obtaining,” “creating,” “generating,” “mapping,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

What is claimed is:

1. A method comprising:
receiving, by a processing device executing an integrated development environment (IDE), an indication of a selected source code portion within source code;
identifying, by the processing device in view of a set of mappings, a visual representation corresponding to the selected source code portion, wherein the set of mappings comprises a mapping defined between the visual representation and the selected source code portion; and
displaying, by the processing device, the visual representation corresponding to the selected source code portion as a rendering preview of the selected source code portion.

2. The method of claim 1, wherein the source code corresponds to a web application and the source code portion is an HTML source code portion.

3. The method of claim 1, further comprising obtaining, by the processing device, the set of mappings, wherein obtaining the set of mappings comprises:
generating the visual representation; and
mapping the visual representation to the selected source code portion.

4. The method of claim 3, wherein the set of mappings is comprised within a configuration file defining the mapping between the visual representation and the selected source code portion.

5. The method of claim 4, wherein the mapping is defined by a pointer to a location of the selected source code portion within the source code, and a path to a visual representation file corresponding to the visual representation.

6. The method of claim 3, wherein mapping the visual representation to the selected source code portion comprises naming a visual representation file corresponding to the visual representation in view of an attribute of the source code portion.

7. The method of claim 1, wherein the visual representation is represented by a screenshot.

8. A system comprising:
a memory; and
a processing device executing an integrated development environment (IDE), operatively coupled to the memory, to perform operations comprising:
receiving an indication of a selected source code portion within source code;
identifying, in view of a set of mappings, a visual representation corresponding to the selected source code portion, wherein the set of mappings comprises a mapping defined between the visual representation and the selected source code portion; and
displaying the visual representation corresponding to the selected source code portion as a rendering preview of the selected source code portion.

9. The system of claim 8, wherein the source code corresponds to a web application and the source code portion is an HTML source code portion.

10. The system of claim 8, wherein the operations further comprise obtaining the set of mappings, and wherein obtaining the set of mappings comprises:
generating the visual representation; and
mapping the visual representation to the selected source code portion.

11. The system of claim 10, wherein the set of mappings is comprised within a configuration file defining the mapping between the visual representation and the selected source code portion.

12. The system of claim 11, wherein the mapping is defined by a pointer to a location of the selected source code portion within the source code, and a path to a visual representation file corresponding to the visual representation.

13. The system of claim 10, wherein mapping the visual representation to the selected source code portion comprises creating a visual representation file corresponding to the visual representation having a name defined in view of an attribute value of the source code portion.

14. The system of claim 8, wherein the visual representation is represented by a screenshot.

15. A non-transitory machine-readable storage medium storing instructions that, when executed by a processing device executing an integrated development environment (IDE), cause the processing device to perform operations comprising:
receiving an indication of a selected source code portion within source code;
identifying, in view of a set of mappings, a visual representation corresponding to the selected source code portion, wherein the set of mappings comprises a mapping defined between the visual representation and the selected source code portion; and
displaying the visual representation corresponding to the selected source code portion as a rendering preview of the selected source code portion.

16. The non-transitory machine-readable storage medium of claim 15, wherein the source code corresponds to a web application and the source code portion is an HTML source code portion.

17. The non-transitory machine-readable storage medium of claim 15, wherein the operations further comprise obtaining the set of mappings, and wherein obtaining the set of mappings comprises:
generating the visual representation; and
mapping the visual representation to the selected source code portion.

18. The non-transitory machine-readable storage medium of claim 15, wherein the set of mappings is comprised within a configuration file defining the mapping between the visual representation and the selected source code portion, and wherein the mapping is defined by a pointer to a location of the selected source code portion within the source code, and a path to a visual representation file corresponding to the visual representation.

19. The non-transitory machine-readable storage medium of claim 15, wherein mapping the visual representation to the selected source code portion comprises creating a visual representation file corresponding to the visual representation having a name defined in view of an attribute value of the source code portion.

20. The non-transitory machine-readable storage medium of claim 15, wherein the visual representation is represented by a screenshot.
